(19) United States
(12) Patent Application Publication
(10) Pub. No.: US 2023/0034629 A1
(43) Pub. Date: Feb. 2, 2023

(54) LIQUID SPRAY APPARATUS

(71) Applicant: TNH CAR WASH INC., Barrie (CA)

(72) Inventor: Ankitkumar SHAH, Barrie (CA)

(21) Appl. No.: 17/390,050

(22) Filed: Jul. 30, 2021

(51) Int. Cl. B05B 1/20; B60S 3/04

(52) U.S. Cl. CPC B05B 1/20; B60S 3/04

(57) ABSTRACT

A manifold arrangement for a car wash liquid spray apparatus. The manifold arrangement has a water intake manifold and a plurality of nozzle manifolds in fluid communication with and extending from the water intake manifold having a plurality of liquid-expelling nozzles at varying distances away from the water intake manifold. A car wash liquid spray apparatus further has a bracket for mounting the apparatus to a car wash, the bracket having a pair of opposed supports, and the water intake manifold is rotatably coupled to the pair of opposed supports.

### TECHNICAL FIELD

The following relates generally to a liquid spray apparatus, and more particularly to an apparatus for liquid spray in an automatic car wash.

### BACKGROUND

Conveyor car washes are commercial vehicle washing structures within which a vehicle is pulled underneath a series of arches each having sprays or soft wash cloth materials that cooperate to remove dirt from the vehicle. They are also sometimes called tunnels. These car washes use copious amounts of water, which is both financially and environmentally expensive.

Most of the water is consumed during various stages of the wash cycle, including wetting of the vehicle, high pressure passes, initial rinses, and washing of the vehicle. High pressure passes complement the cleaning or rinsing action in a soft touch friction tunnel system.

The application of high pressure water is accomplished through a spray apparatus having a plurality of nozzles. An exemplary applicator is disclosed in United States Patent Publication No. 2010/0154843 to Ennis.

A typical existing spray apparatus is shown with a front view in FIG. 1A and a side view thereof in FIG. 1B. Such an apparatus may be placed on an arch disposed at the side, above or even beneath the vehicle.

This apparatus (100) generally has a water intake manifold (102) coupled to a water supply hose (not shown). The water intake manifold (102) is in fluid communication with pairs of nozzle manifolds (104, 106) via conduits (108). The water intake manifold (102) and nozzle manifolds are disposed such that nozzles (110) at the end of each nozzle manifold (104, 106) are disposed along substantially parallel lines to the water intake manifold (102), essentially the nozzles (110) for a pair of generally horizontal (coplanar) parallel lines. The plurality of nozzles (110) extend from the nozzle manifolds (104, 106) to expel water (112) at a high pressure toward the vehicle. Typical applications use 4 or 5 nozzles per nozzle manifold.

The entire apparatus (100) oscillates by an actuator or motor assembly (not shown) with its rotational axis being the water intake manifold (102) at a predetermined angular disposition. For example, if the apparatus (102) is disposed at a height that is approximately half the height of an average vehicle, it may be caused to actuate along a range of approximately 70 to 90°. As the vehicle is conveyed alongside the apparatus (102), the apparatus (102) oscillates up and back down repeatedly while spraying the vehicle surface.

In practice, the rotation of the apparatus, while effective, consumes more water than is necessary, as water (112) expelled from a particular one of the nozzles (110) will tend to impact the vehicle at substantially the same location as water (112) from a preceding nozzle (110) since adjacent nozzles are relatively close together and essentially coplanar.

It is an object of the following to mitigate or obviate the foregoing disadvantages.

### SUMMARY

In one aspect, a manifold arrangement for a car wash liquid spray apparatus is provided, the manifold arrangement comprising: a water intake manifold; and a plurality of nozzle manifolds in fluid communication with and extending from the water intake manifold having a plurality of liquid-expelling nozzles at varying distances away from the water intake manifold.

In another aspect, a car wash liquid spray apparatus is provided, the apparatus comprising: a bracket for mounting the apparatus to a car wash, the bracket comprising a pair of opposed supports; a water intake manifold rotatably coupled to the pair of opposed supports; an oscillator mounted to the bracket, the oscillator coupled to the water intake manifold by a crank linkage system to oscillate the water intake manifold between an upper extend and a lower extent; and a plurality of nozzle manifolds in fluid communication with and extending from the water intake manifold having a plurality of liquid-expelling nozzles at varying distances away from the water intake manifold.

### DESCRIPTION OF THE DRAWINGS

A greater understanding of the embodiments will be had with reference to the Figures, in which:

FIG. 1A is a front view of a typical existing spray apparatus;

FIG. 1B is a side view of the apparatus of FIG. 1A;

FIG. 2 is a right side perspective view of an apparatus in accordance with the invention;

FIG. 3 is a front view of the apparatus of FIG. 2;

FIG. 4A is a left side perspective view of the apparatus of FIG. 2 mounted to a post of a car wash;

FIG. 4B is left side view of the apparatus and post of FIG. 4A; and

FIG. 5 illustrates three apparatus mounted to a car wash.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

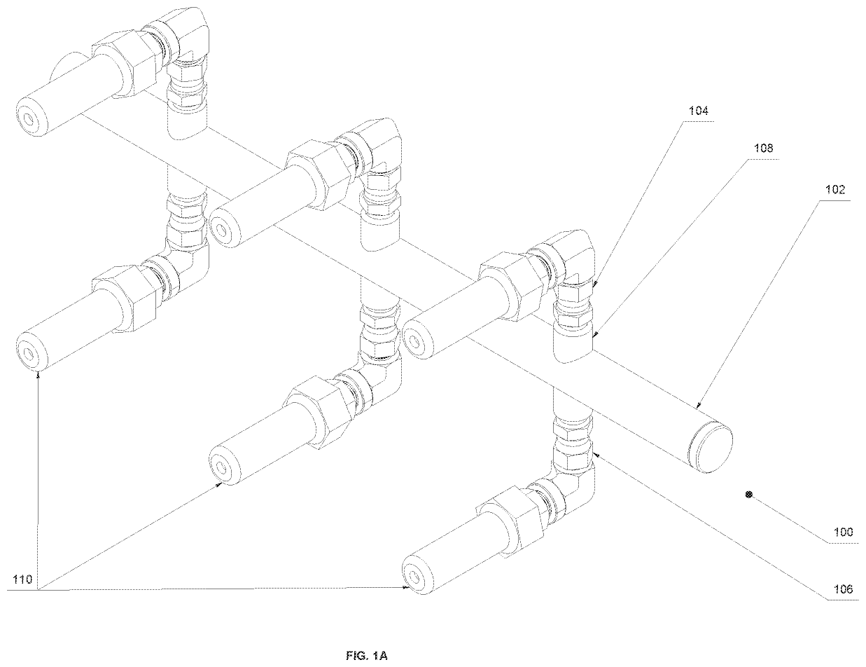

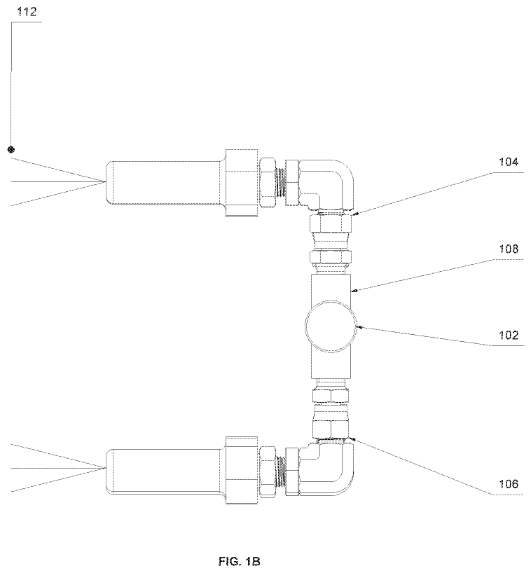

The following provides a liquid spray apparatus, and more particularly an apparatus for liquid spray in an automatic car wash. Contrary to the prior apparatus of FIG. 1, the apparatus disclosed herein provides a unique and beneficial arrangement of water expelling nozzles.

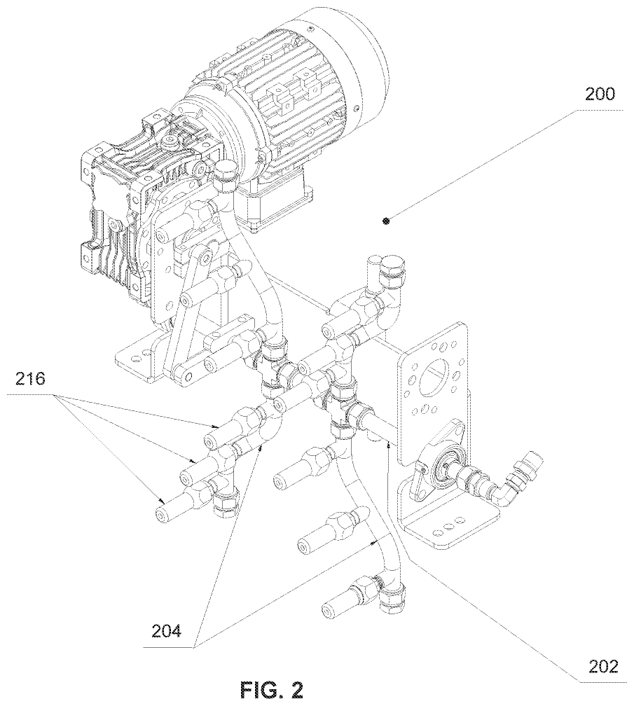

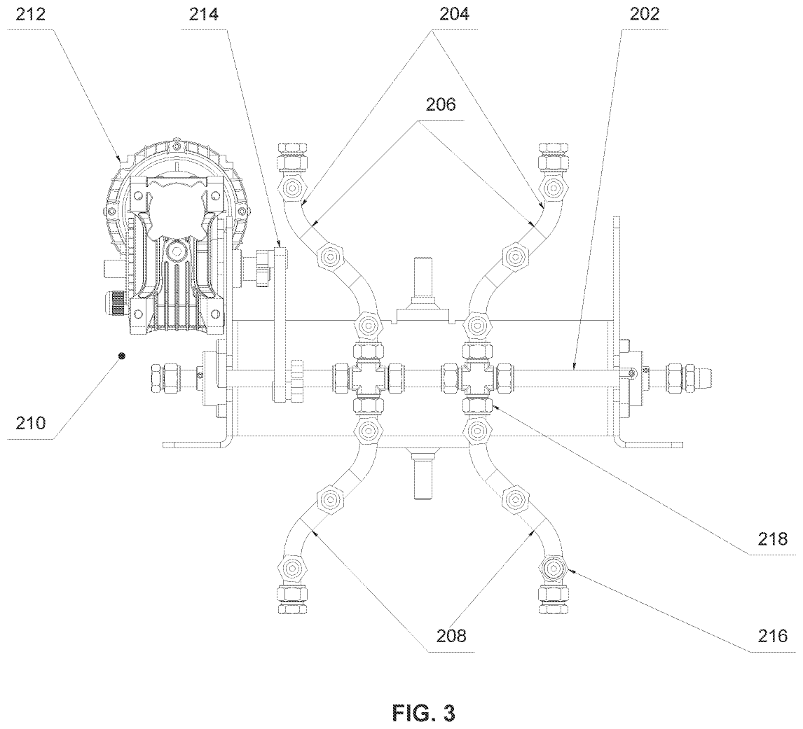

Referring now to FIG. 2 and FIG. 3, in an exemplary embodiment, the apparatus (200) comprises a water intake manifold (202) in fluid communication with a pair of nozzle manifolds (204). The nozzle manifolds (204) are coupled to the intake manifold (202) and extend therefrom at a generally right angle, although a conduit could be used in other implementations, and the angle could vary. As will be appreciated with reference to the drawings, each nozzle manifold (204) could be formed from separate units such as an upper nozzle manifold (206) and a lower nozzle manifold (208). Similarly, the water intake manifold may comprise multiple units, as shown, coupled together by various threaded or adhered couplings (218).

The apparatus (200) oscillates along an axis defined by the water intake manifold (202) wherein oscillation is accomplished by use of an oscillator (210), an example of which is described below.

In contrast to the apparatus shown in FIG. 1A, each of the nozzle manifolds (204) has a plurality of nozzles (216) extending therefrom in the direction of the vehicle, wherein the nozzles (216) of a particular nozzle manifold (204) are arranged at vary distances away from the water intake manifold, and as shown are horizontally offset from one another. Preferably, at least two nozzles (216) extend from each of the upper nozzle manifold (206) and lower nozzle manifold (208) of each one of the nozzle manifolds (204) providing a total of at least eight nozzles for the apparatus (200), and at least 3, but preferably at least 4, horizontally coplanar nozzle pairs (or sets of more than two in alternative embodiments).

As can be seen, the disclosed nozzle arrangement results in the nozzles being arranged primarily along the vehicle height rather than width.

As can be seen, the nozzle manifolds (204) are not entirely parallel to the water intake manifold (202). In the illustrated embodiment, no portion of the nozzle manifolds (204) is parallel to the water intake manifold (202). Rather, in the illustrated embodiment each of the nozzle manifolds (204) may extend substantially perpendicularly from the water manifold (202). This arrangement may be accomplished using a typical T or elbow threaded coupling. Thus, in a preferred embodiment as shown, the nozzle manifolds (204) are coupled to the water manifold (202) at a right-angle based threaded coupling (218) and extend curvilinearly therefrom. The figures show a generally S-shaped upper nozzle manifold (206) and lower nozzle manifold (208) extending from the water manifold (202) which combine to provide opposing bull-horn shaped nozzle arrangements. It will be appreciated that the coupling can be made at other than perpendicular angles if desired as it is the nozzle arrangement that is most preferred.

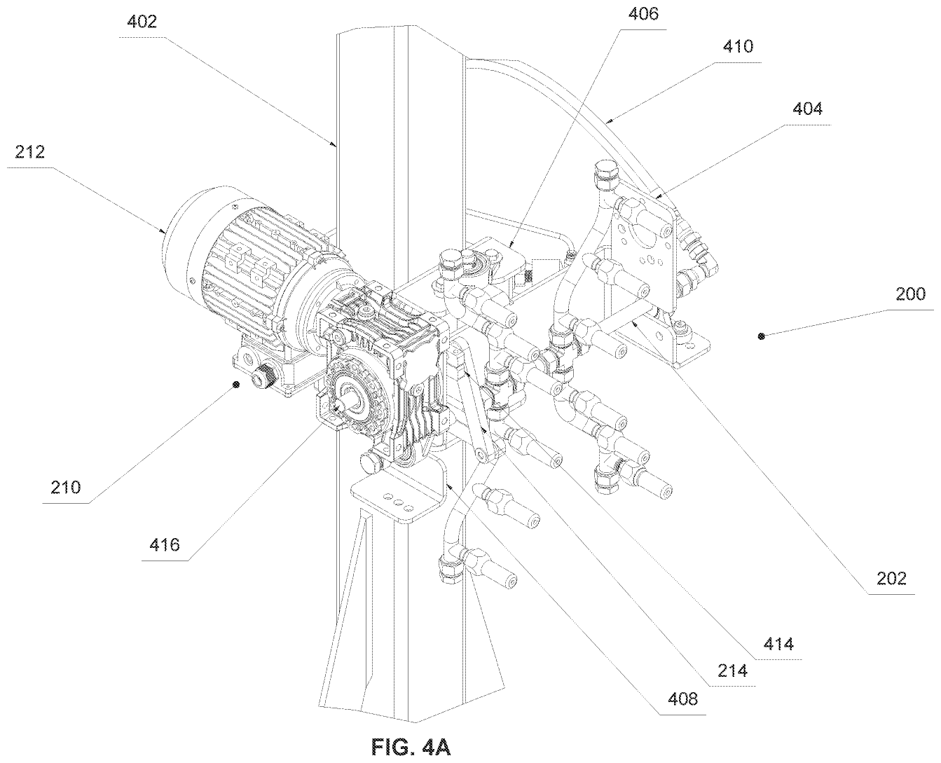

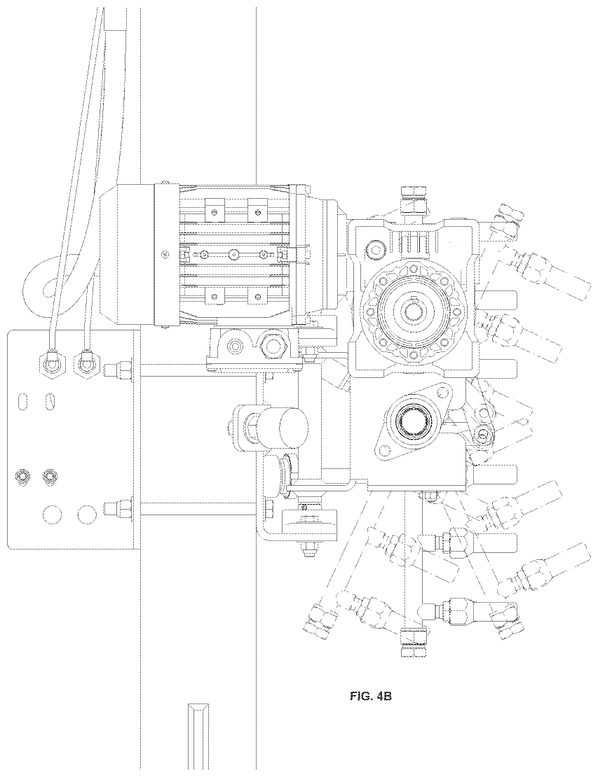

An exemplary oscillator is shown in FIG. 4A and FIG. 4B. The apparatus (200) is shown mounted to a post (402) by a bracket (404). The bracket (404) may be formed from multiple pieces joined together. The bracket (404) includes an opposed pair of supports (406, 408), each of which supports the water intake manifold (202) and permits rotation thereof. A water supply hose (410) is coupled to the water intake manifold (202) adjacent an external surface of one of the supports (406) (i.e., adjacent the surface further away from the bulk of components of the apparatus). The other of the two supports (408) further has mounted thereto an oscillator (210). The bracket (404) is mounted to the post (402) such that the water manifold (202) is substantially parallel to the ground. The post (402) is generally stationary in facilities in which the vehicle is conveyed or moves alongside the vehicle in others.

The oscillator (210) comprises a motor unit (212) and a crank linkage system (214). The support (408) that supports the oscillator may comprise an annular motor mount clamp (414) to rotatably support the output shaft (416) of the motor unit (212). The motor unit (212) preferably is an electric drive or hydraulic drive that is coupled to and causes rotation of the crank linkage system (214). The crank linkage system (416) is coupled at its other end to the water manifold (202) to cause oscillation of the water manifold (202) about an axis substantially parallel to the ground.

Oscillation of the water manifold (202) in turn causes the nozzle manifolds (204) to oscillate between an upper extent and a lower extent. In most cases, the upper extent and lower extent can be approximately the same angle from normal, however there could be reasons to have different upper and lower extents, such as where the apparatus (200) must be placed either unusually higher or lower than the mid-height of a typical vehicle. The applicant has found that oscillation of a total 30-degree extent is suitable in typical applications, however the stated range is not intended as limiting and any suitable range could be used subject to physical limitations of the various components of the apparatus and the car wash.

The nozzles are preferably set to provide a relatively narrow jet i.e., substantially zero degree, since the water manifold (202) is oscillated to provide coverage. An electric or hydraulic motor output speed may be set at 70-75 cycles per minute for an automatic exterior car wash. An oscillation rate on the order of 70-75 cycles per minute has been found to provide adequate coverage.

In the foregoing, any or all of the rotational couplings and supports preferably include bearings to reduce friction and increase lifespan.

The nozzle arrangement shown and described can be utilized to provide better vehicle coverage with less water than the prior known arrangements. Such an advantage is best understood for applications where the apparatus is disposed alongside a vehicle. In these applications, the nozzles are disposed vertically rather than horizontally while oscillation occurs on a horizontal axis. In other words, the distance between the upper most and lower most nozzle is more than the distance between the left most and right most nozzle. Therefore, the oscillation can be reduced compared to prior techniques resulting in more water per nozzle per time unit impacting any particular area of the vehicle and, therefore, a corresponding ability to reduce such water usage. Furthermore, greater impingement also allows for the use of smaller nozzle sizes with lower flow rates without sacrificing cleaning performance.

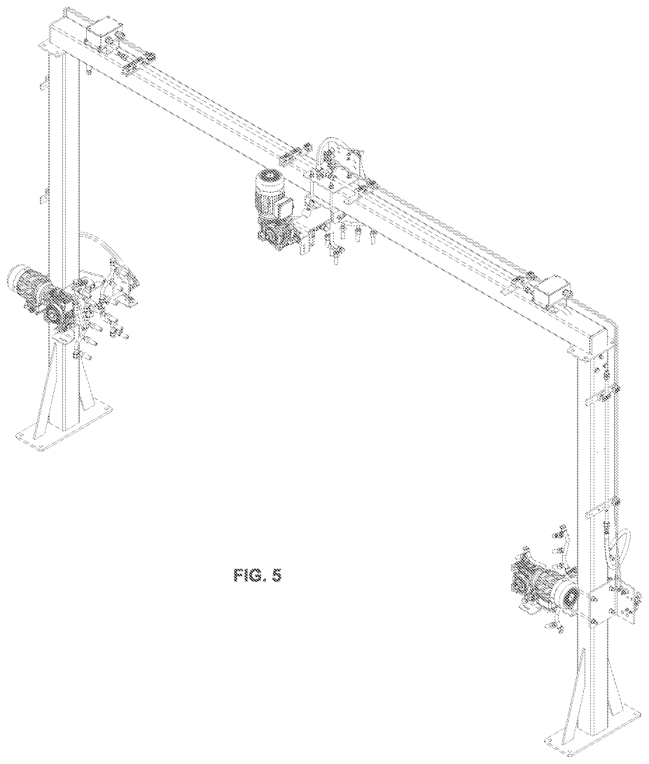

In use, the apparatus can be used at least on both sides of the vehicle. An additional apparatus may be used on above the vehicle as well, as shown in FIG. 5.

Although the foregoing has been described with reference to certain specific embodiments, various modifications thereto will be apparent to those skilled in the art without departing from the spirit and scope of the invention as outlined in the appended claims.

1. A manifold arrangement for a car wash liquid spray apparatus, the manifold arrangement comprising:
a water intake manifold; and
a plurality of nozzle manifolds in fluid communication with and extending from the water intake manifold having a plurality of liquid-expelling nozzles at varying distances away from the water intake manifold.

2. The manifold arrangement of claim 1, wherein the plurality of nozzle manifolds comprise at least one upper nozzle manifold and at least one lower nozzle manifold.

3. The manifold arrangement of claim 2, consisting of two upper nozzle manifolds and two lower nozzle manifolds.

4. The manifold arrangement of claim 1, wherein each of the plurality of nozzle manifolds comprise more than one nozzle extending therefrom for expelling liquid.

5. The manifold arrangement of claim 4, comprising at least two nozzles extending from each nozzle manifold.

6. The manifold arrangement of claim 3, wherein the two upper nozzle manifolds and the two lower nozzle manifolds form opposing bull-horn shapes.

7. The manifold arrangement of claim 1, wherein the nozzle manifolds extend substantially perpendicularly from the water intake manifold.

8. The manifold arrangement of claim 1, wherein the nozzle manifolds extend at an angle from the water intake manifold.

9. The manifold arrangement of claim 1, wherein a distance between the upper most and lower most nozzle is more than a distance between the left most and right most nozzle.

10. The manifold arrangement of claim 1, wherein each of the nozzle manifolds is coupled to the water intake manifold by a threaded coupling.

11. The manifold arrangement of claim 1, wherein each nozzle has a substantially zero degree jet.

12. A car wash liquid spray apparatus comprising:
a bracket for mounting the apparatus to a car wash, the bracket comprising a pair of opposed supports;
a water intake manifold rotatably coupled to the pair of opposed supports;
an oscillator mounted to the bracket, the oscillator coupled to the water intake manifold by a crank linkage system to oscillate the water intake manifold between an upper extend and a lower extent; and
a plurality of nozzle manifolds in fluid communication with and extending from the water intake manifold having a plurality of liquid-expelling nozzles at varying distances away from the water intake manifold.

13. The car wash liquid spray apparatus of claim 12, wherein the plurality of nozzle manifolds comprise at least one upper nozzle manifold and at least one lower nozzle manifold.

14. The car wash liquid spray apparatus of claim 13, consisting of two upper nozzle manifolds and two lower nozzle manifolds

15. The car wash liquid spray apparatus of claim 12, wherein each of the plurality of nozzle manifolds comprise more than one nozzle extending therefrom for expelling liquid.

16. The car wash liquid spray apparatus of claim 15, comprising at least two nozzles extending from each nozzle manifold.

17. The car wash liquid spray apparatus of claim 16, wherein the two upper nozzle manifolds and the two lower nozzle manifolds form opposing bull-horn shapes.

18. The car wash liquid spray apparatus of claim 12, wherein the nozzle manifolds extend substantially perpendicularly from the water intake manifold.

19. The car wash liquid spray apparatus of claim 12, wherein the nozzle manifolds extend at an angle from the water intake manifold.

20. The car wash liquid spray apparatus of claim 12, wherein a distance between the upper most and lower most nozzle is more than a distance between the left most and right most nozzle.

21. The car wash liquid spray apparatus of claim 12, wherein each of the nozzle manifolds is coupled to the water intake manifold by a threaded coupling.

22. The car wash liquid spray apparatus of claim 12, wherein the upper extent and the lower extent are approximately the same angle from normal.

23. The car wash liquid spray apparatus of claim 12, wherein oscillation of the water intake manifold occurs over an approximately 30° range.

24. The car wash liquid spray apparatus of claim 13, wherein each nozzle has a substantially zero degree jet.

25. The car wash liquid spray apparatus of claim 12, wherein each nozzle has a substantially zero degree jet.

26. The car wash liquid spray apparatus of claim 12, having an oscillation rate between 70 and 75 cycles per minute.

27. The car wash liquid spray apparatus of claim 12, wherein the bracket is mounted to the car wash so that the water intake manifold is substantially parallel to the ground.
